(19) United States
(12) Patent Application Publication
(10) Pub. No.: US 2012/0300436 A1
(43) Pub. Date: Nov. 29, 2012

(54) LIGHTING ARRANGEMENT AND A MOVABLE LAMPSHADE

(76) Inventors: Domnic Anthony Hackett, Dublin (IE); Joseph Patrick Hackett, Dublin (IE); Gavin John Galligan, Dublin (IE)

(21) Appl. No.: 13/512,688

(22) PCT Filed: Nov. 30, 2010
(86) PCT No.: PCT/EP10/68543

§ 371 Date: Jul. 31, 2012

(30) Foreign Application Priority Data
Nov. 30, 2009 (IE) S2009/0905
Nov. 3, 2010 (GB) 1004057.4

(51) Int. Cl. F21V 1/10; F21V 1/00; F21V 1/02; F21L 4/08

(52) U.S. Cl. 362/127; 362/187; 362/153

(57) ABSTRACT

A lighting arrangement (1, 51, 71, 91, 111, 141, 161, 181, 211) having an arrangement (14, 15, 44, 45, 77, 97) for coupling the lighting arrangement to a bulb holder (4, 75, 95, 115, 165, 185, 215) and a lampshade (3, 33, 53, 84, 113, 142) supported on the coupling arrangement (14, 15, 44, 45, 77, 97). The lighting arrangement having an arrangement (2,) for causing relative movement between at least a portion of the lampshade (3, 33, 53, 84, 104, 113, 142) and the coupling arrangement (14, 15, 44, 45, 77, 97), the movement causing arrangment (2) comprising a transducer (5) for converting solar energy to electrical energy.

The present invention relates to a lighting arrangement and in particular to a lighting arrangement with a movable lampshade.

Lighting arrangements of all types are well known in the art from pendant type lighting arrangements to floor lighting arrangements and table mounted lighting arrangements. A number of novelty lighting arrangements have incorporated movable lampshades which move as a result of convection currents and still other lighting arrangements have incorporated an additional power source such as a motor to cause rotation of the lampshade relative to the remainder of the lighting arrangement. The convection current technology requires careful design in relation to weight and material selection to accommodate the relevant physical principles at work between the air and the lampshade. The additional motor type lamps provide greater control for the rotation of the lampshade than the convection current styled lighting arrangements. However, the additional motor adds an extra load on the domestic or commercial electricity supply and adds to the overall operating costs of the lighting arrangement which is a major deterrent to eco friendly users.

It is an object of the present invention to provide a novelty lighting arrangement with a rotating lampshade obviating or mitigating the design complexity problems of the convection current type of lighting arrangements and obviating or mitigating the additional power consumption requirements of the extra motor type of lighting arrangements.

Accordingly, the present invention provides a lighting arrangement having a means for coupling the lighting arrangement to a bulb holder and a lampshade supported on the coupling means, the lighting arrangement having means for causing relative movement between at least a portion of the lampshade and the coupling means, the movement causing means comprising a transducer for converting solar energy to electrical energy.

Advantageously, the transducer is capable of converting a portion of the existing light energy from a light source mountable in a light fitting into useful electrical energy which is otherwise unused dissipating into the atmosphere.

Ideally, the movement causing means further comprises actuator means powered by the electrical energy generated by the transducer.

Preferably, the actuator means is a motor.

Ideally, the actuator means is operably engaged between the transducer and a portion of the lampshade for causing relative movement between at least a portion of the lampshade and the coupling means.

Preferably, the motor has a driveshaft operably engaged with a rotatable portion of at least a portion of the lampshade.

In a first embodiment of coupling means, the coupling means is a coupling support frame. The coupling support frame is preferably separate to a lampshade support frame.

Ideally, the movement causing means is mounted on the coupling support frame.

Preferably, the coupling support frame comprises a wire frame having a first ring connectable to a light bulb holder and a second ring for engaging the motor thereon and for receiving the driveshaft of the motor there through.

Ideally, the drive shaft of the motor is operably engaged with a rotatable portion of the lampshade.

Preferably, the lampshade has a first inner rotatable lampshade member and a second outer lampshade member fixable to the light source, the second outer lampshade member having at least one aperture.

Ideally, the inner lampshade member and the outer lampshade member are of similar shape and are concentric.

In a second embodiment of coupling means, the lampshade has a lampshade support frame and the coupling means is a part of the lampshade support frame.

Preferably, the lampshade has an outer lampshade member fixable to the light source via the coupling means and an inner lampshade member movably mounted on the outer lampshade member via the movement causing means.

Ideally, the inner lampshade member and the outer lampshade member are of similar shape and are concentric.

Preferably, the movement causing means have the motor and transducer mounted on the support frame of the outer lampshade member.

Ideally, the support frame of the inner lampshade member has a recess for receiving the motor and a connector for engaging the drive shaft of the motor.

Preferably, the lampshade has a number of mobiles attached thereto.

Ideally, the lighting arrangement is attachable to a pendant type light fitting, a pendant centre light, a recessed light, a table lamp or a floor lamp.

Ideally, the transducer is provided by at least one photo voltaic solar cell for converting solar to electrical energy.

Ideally, the light source is mounted in a light fitting comprising a bulb holder and a locking cap for securing a coupling means onto the bulb holder.

Preferably, the light source is a recessed light.

In an alternative embodiment, the actuator means is a fan blowing a stream of air onto a rotatable portion of the lampshade.

In this alternative embodiment, the rotatable portion of the lampshade has turbine means.

Ideally, the transducer is located for collecting at least a portion of the light from a powered light source mountable in the lighting arrangement.

Preferably, the transducer is capable of collecting at least some of the light from the sun and converting a portion of the existing sunlight energy into useful electrical energy which is otherwise unused.

Preferably, the light source is a bulb.

Ideally, the inner lampshade member and the outer lamp shade member have a generally cylindrical wire support frame covered in a partially transparent material for partially transmitting light from the light source. Although the shape of the wire support frame is described as generally cylindrical, it will of course be appreciated that any well known shape of lamp shade can be used with the present invention such as hemispherical or frusto-conical.

Ideally, a centre light fitting is provided having a plurality of lighting arrangements each having a coupling means and a lampshade, the lighting arrangement having means for causing relative movement between at least a portion of the lampshade and the coupling means, the movement causing means comprising a transducer for converting solar energy to electrical energy.

Preferably, the rotational motion of the motor is converted into linear motion. Ideally, at least a portion of the lampshade can be moved in a straight line relative to the coupling means and the remainder of the lampshade. Advantageously, the linear motion can be applied to mobiles on the lampshade to provide the effect of characters moving up and down on the lampshade, internally or externally.

Ideally, sound generating means are electrically or electronically couplable to the transducer. Advantageously, the sound generating means can generate music through a loudspeaker for example to play musical sounds and/or songs such as childrens' lullaby using solar energy normally wasted.

The invention will now be described with reference to the accompanying drawings which show by way of example only twelve embodiments of a lighting arrangement in accordance with the invention. In the drawings:—

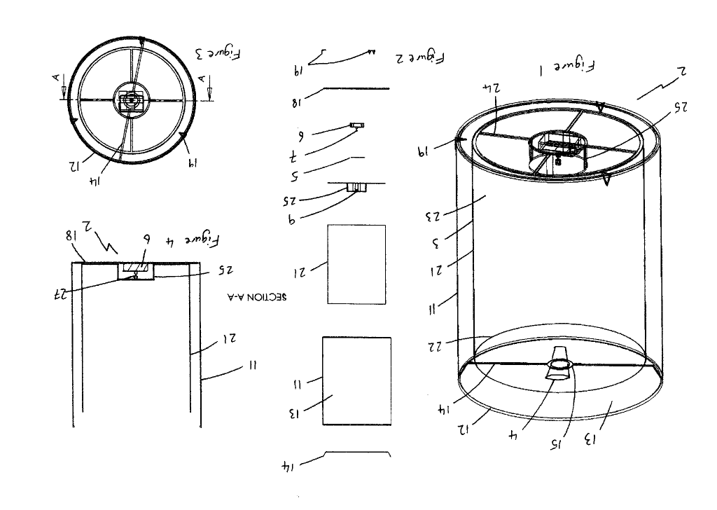

FIG. 1 is a perspective view of a first embodiment of a pendant type lighting arrangement and movable lampshade in accordance with the invention;

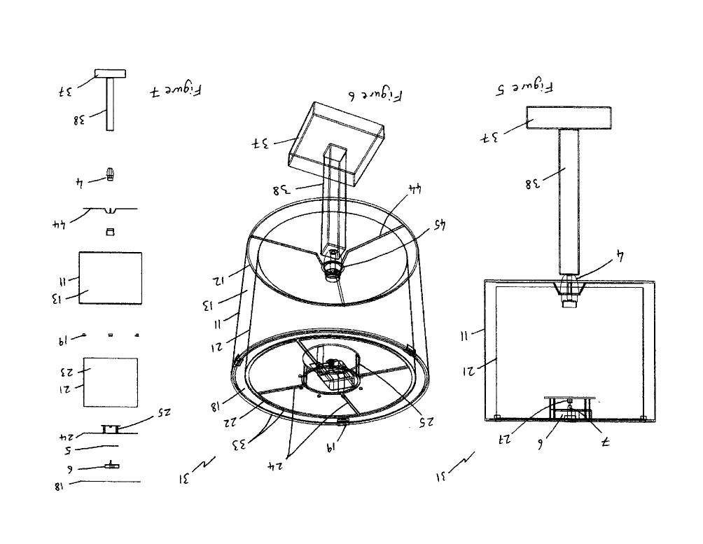

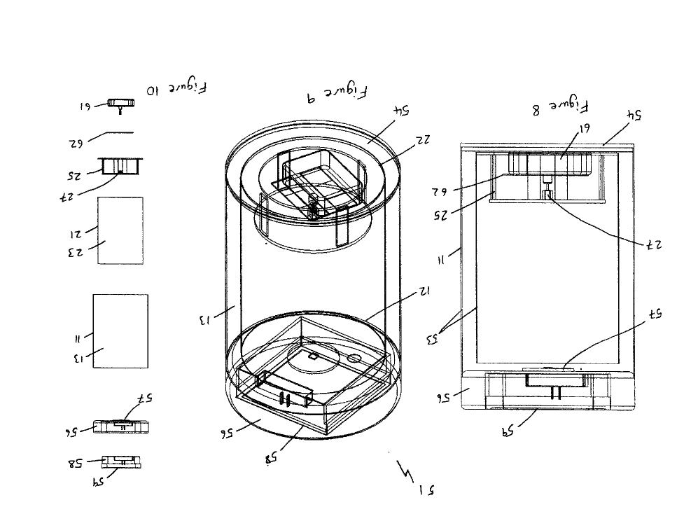

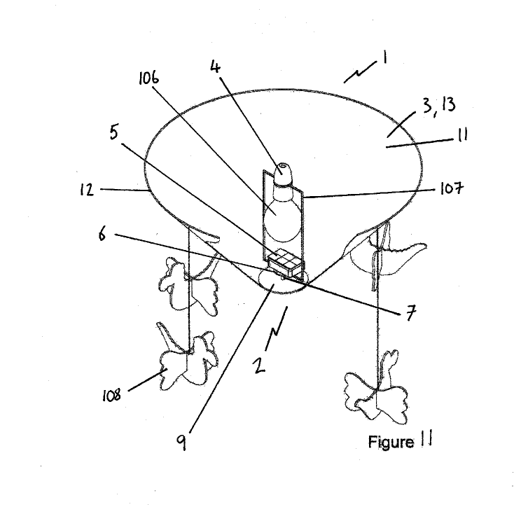

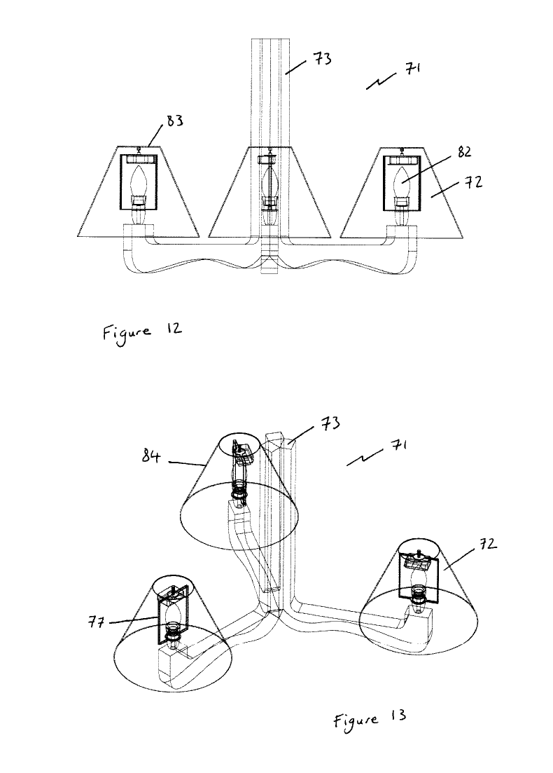

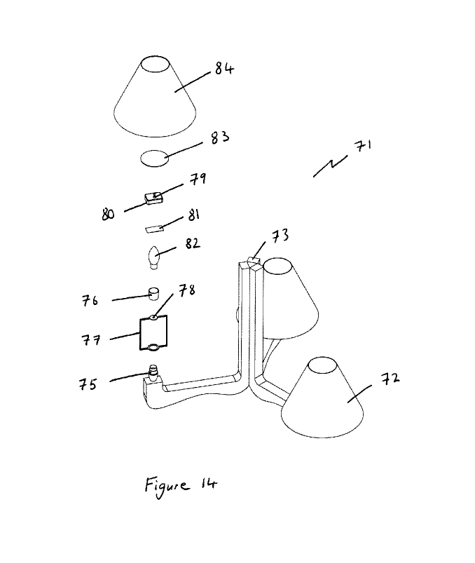

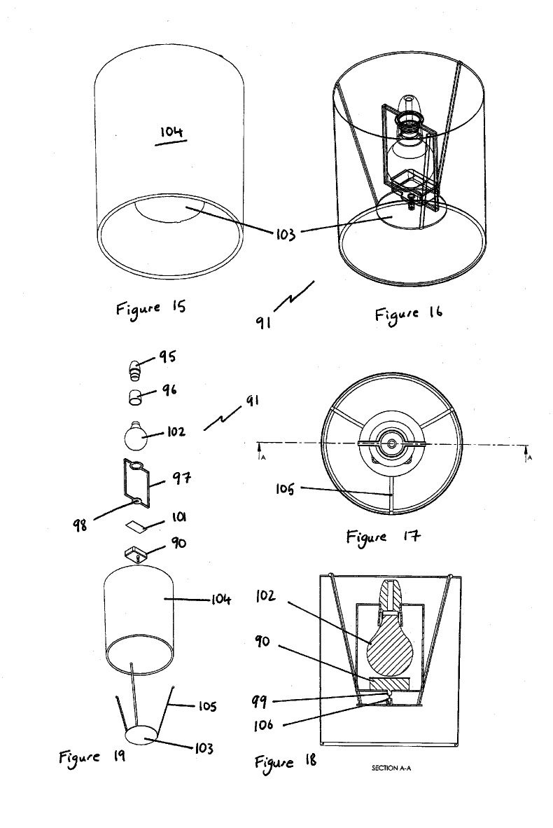

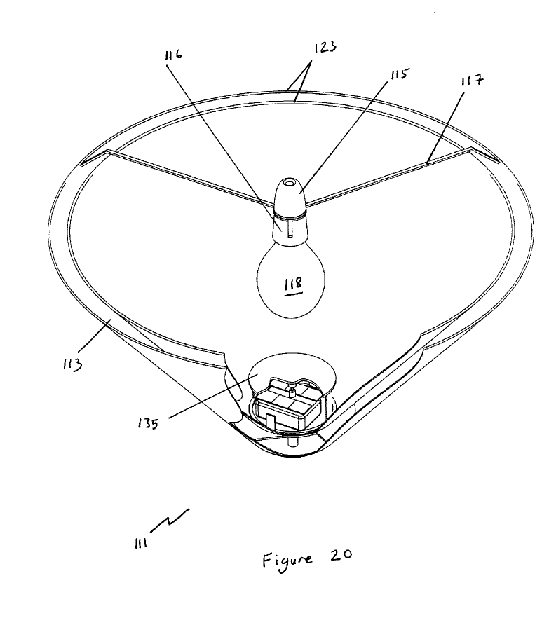

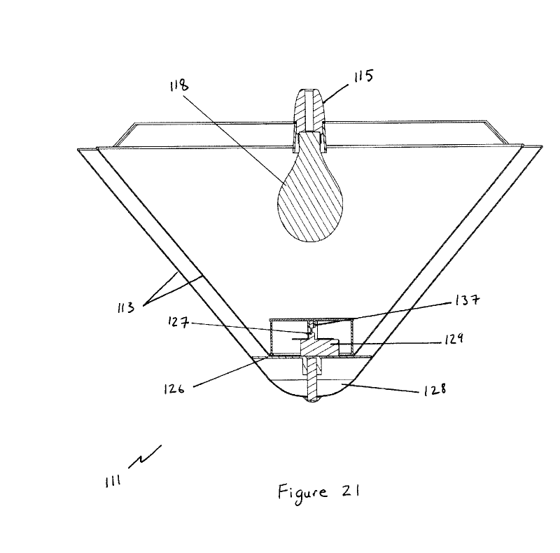

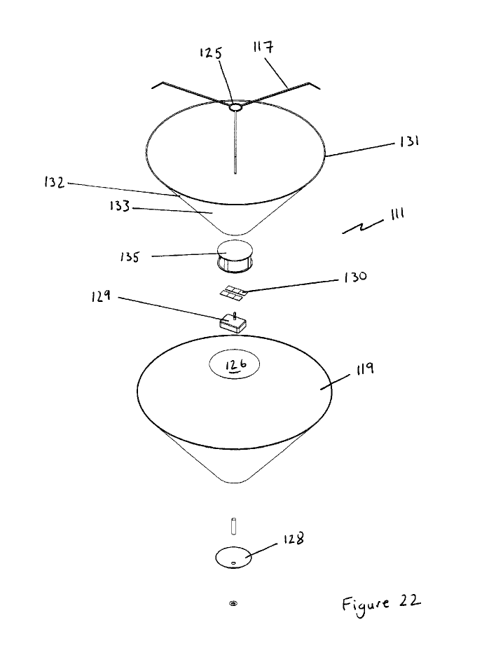

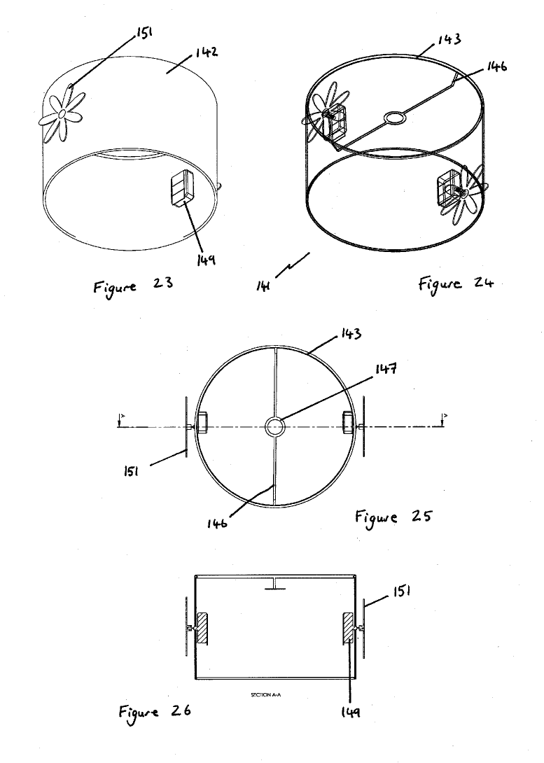

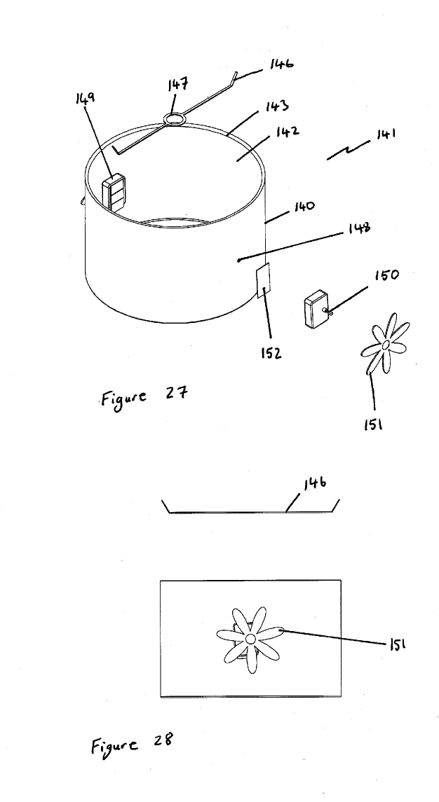

FIG. 2 is an exploded view of FIG. 1;

FIG. 3 is a top plan view of FIGS. 1 and 2;

FIG. 4 is a section view of FIG. 3 taken along lines A-A;

FIG. 5 is an elevational view of a second embodiment of an upstanding lighting arrangement and movable lampshade in accordance with the invention;

FIG. 6 is a perspective view of FIG. 5;

FIG. 7 is an exploded view of FIGS. 5 and 6;

FIG. 8 is an elevational view of a third embodiment of an upstanding lighting arrangement and movable lampshade in accordance with the invention;

FIG. 9 is a perspective view of FIG. 8;

FIG. 10 is an exploded view of FIGS. 8 and 9;

FIG. 11 is a partial perspective cut away view of a fourth embodiment of the invention;

FIG. 12 is a side elevational view of a fifth embodiment of lighting arrangement;

FIG. 13 is a perspective view of the fifth embodiment of lighting arrangement;

FIG. 14 is an exploded view of the fifth embodiment of lighting arrangement;

FIG. 15 is a perspective view of a sixth embodiment of lighting arrangement;

FIG. 16 is a wireframe second perspective view of the sixth embodiment of lighting arrangement;

FIG. 17 is a top plane view of the sixth embodiment of lighting arrangement;

FIG. 18 is a section view of FIG. 17 along line A-A;

FIG. 19 is an exploded view of the sixth embodiment of lighting arrangement;

FIG. 20 is a partial cutaway perspective view of a seventh embodiment of lighting arrangement;

FIG. 21 is a section view of the seventh embodiment of lighting arrangement;

FIG. 22 is an exploded view of the seventh embodiment of lighting arrangement;

FIG. 23 is a perspective view of an eighth embodiment of lighting arrangement;

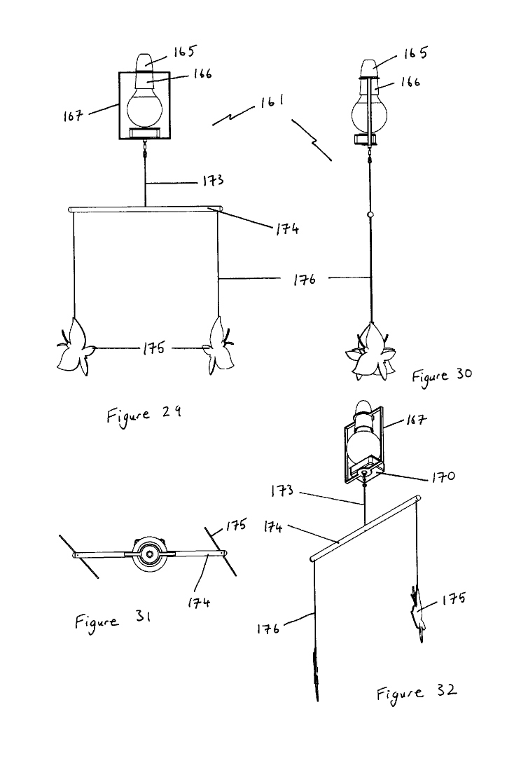

FIG. 24 is a wireframe perspective view of the eighth embodiment of lighting arrangement;

FIG. 25 is top plan view of the eighth embodiment of lighting arrangement;

FIG. 26 is a section view of FIG. 25 taken along line A-A;

FIG. 27 is an exploded view of the eighth embodiment of lighting arrangement;

FIG. 28 is a second exploded view of the eighth embodiment of lighting arrangement;

FIG. 29 is an elevational view of a tenth embodiment of lighting arrangement;

FIG. 30 is a side view of the tenth embodiment of lighting arrangement;

FIG. 31 is top plan view of the tenth embodiment of lighting arrangement;

FIG. 32 is a perspective view of the tenth embodiment of lighting arrangement;

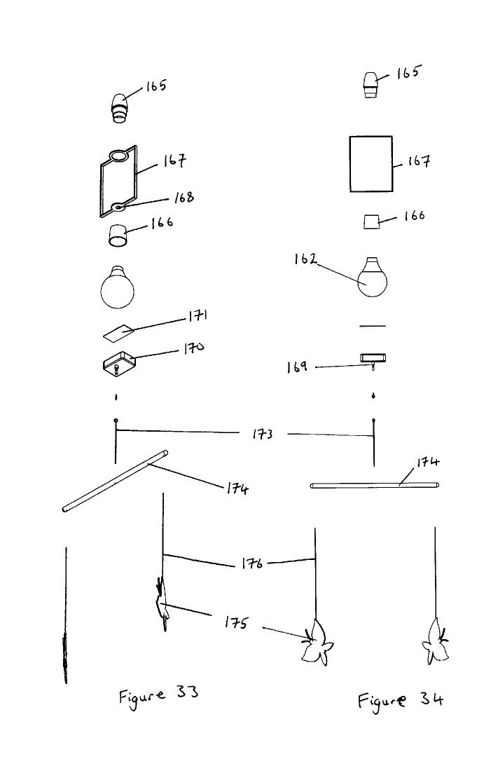

FIG. 33 is a perspective exploded view of the tenth embodiment of lighting arrangement;

FIG. 34 is an elevational exploded view of the tenth embodiment of lighting arrangement;

FIG. 35 is a perspective view of an eleventh embodiment of lighting arrangement;

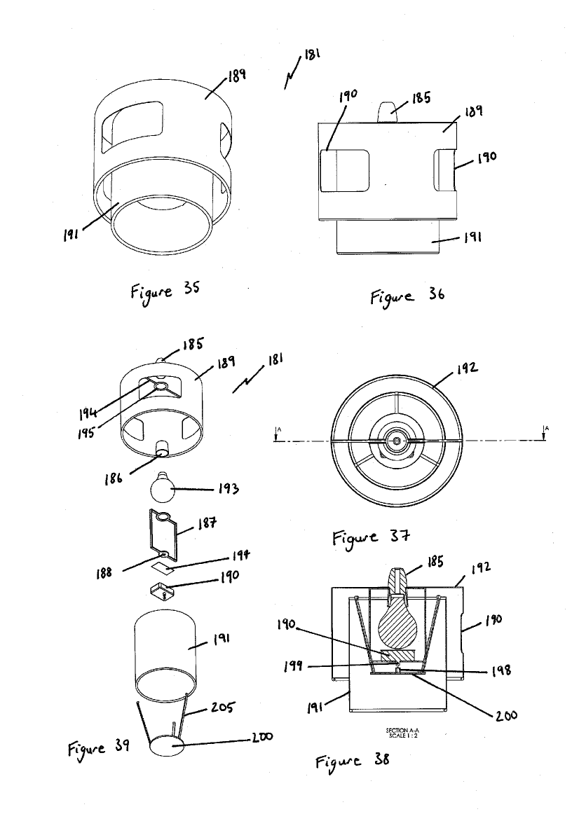

FIG. 36 is an elevation al view of the eleventh embodiment of lighting arrangement;

FIG. 37 is a top plan view of the eleventh embodiment of lighting arrangement;

FIG. 38 is a section view of FIG. 37 taken along line A-A;

FIG. 39 is an exploded perspective view of the eleventh embodiment of lighting arrangement;

FIG. 40 is a wireframe elevational view of a twelfth embodiment of lighting arrangement;

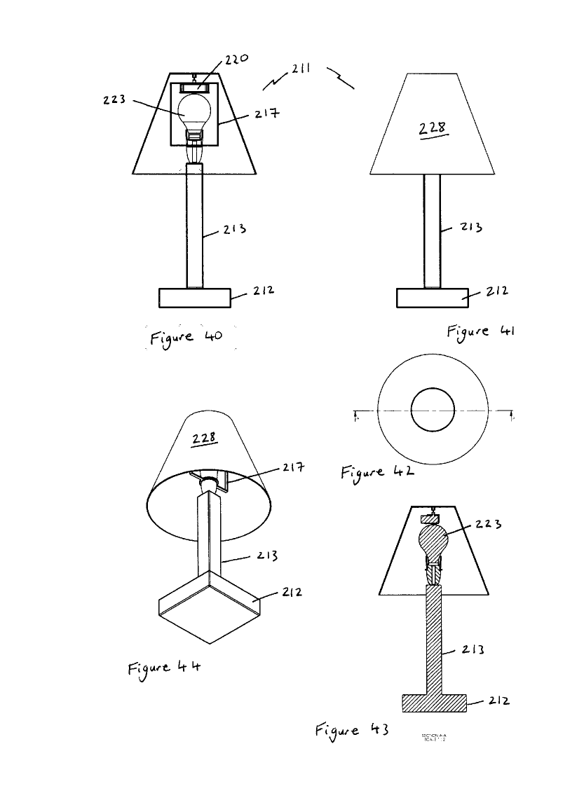

FIG. 41 is a second elevational view of the twelfth embodiment of lighting arrangement;

FIG. 42 is a top plan view of the twelfth embodiment of lighting arrangement;

FIG. 43 is a section view of FIG. 42 taken along line A-A;

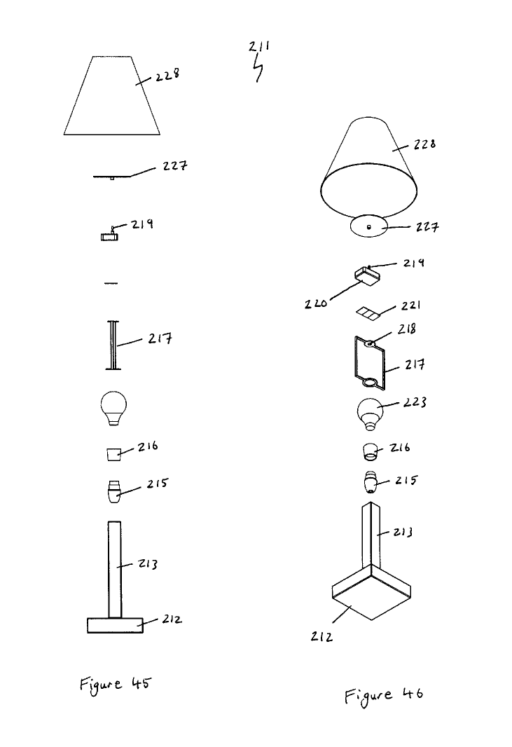

FIG. 44 is a third perspective view of the twelfth embodiment of lighting arrangement;

FIG. 45 is an exploded elevational view of the twelfth embodiment of lighting arrangement; and

FIG. 46 is an exploded perspective view of the twelfth embodiment of lighting arrangement.

In the drawings generally, there is shown a lighting arrangement indicated generally by the reference numeral 1. The lighting arrangement 1 has an arrangement indicated generally by the reference numeral 2 for causing relative movement between at least a portion of the lampshade 3 and the coupling member 14, 15. The arrangement 2 for causing movement has a transducer 5 for converting solar energy to electrical energy.

Advantageously, the transducer 5 is capable of converting a portion of the existing light energy from a light source such as bulb holder 4 and bulb mountable in the coupling member 14, 15 into useful electrical energy which is otherwise unused dissipating into the atmosphere.

The arrangement 2 for causing movement also has an actuator 6 powered by the electrical energy generated by the transducer 5 and in the embodiments shown in the drawings is a motor 6. The motor 6 has a driveshaft 7 operably engageable with a rotatable component 9 of inner lampshade 21.

The motor 6 is operable between the transducer 5 and the rotatable component 9 of the inner lampshade 3 for causing relative movement between the inner lampshade 3 and outer lampshade 11.

The specific configuration of the lampshade 3 shown in FIGS. 1 to 4 has a first outer lamp shade 11 with a generally cylindrical wire support frame 12 covered in a partially transparent material 13 for partially transmitting light from the light source. Although the shape of the wire support frame 12 is described as generally cylindrical, it will of course be appreciated that any well known shape of lamp shade can be used with the present invention such as hemispherical or frusto-conical. The top end of the cylindrical wire support frame 12 has a cross member 14 with a central ring 15 for hanging the outer lamp shade 11 from a pendant light fitting such as a traditional bulb holder 4 and locking cap combination hanging from the ceiling. The bottom end of the cylindrical wire support frame 12 has a base member 18 fastened to the frame 12 by clips 19 for supporting the motor 6 and transducer 5 centrally thereon. The transducer 5 is facing the light source and is provided by photo voltaic solar cells for converting solar to electrical energy.

A second inner cylindrical lamp shade 21 is provided within the outer cylindrical lamp shade 11 and is concentric there with. The inner cylindrical lamp shade 21 also has a generally cylindrical wire support frame 22 covered in a partially transparent material 23 for partially transmitting light from the light source. The top end of the inner cylindrical lamp shade 21 is open and the bottom end of the inner cylindrical lamp shade 21 has a cruciform wire support base 24 supporting a central wire frame recess 25 for receiving the motor 6 and drive shaft 7. The central wire frame recess 25 also supports a connector 27 in alignment with the drive shaft 7 in use for engaging the drive shaft 7 of the motor 6 so that rotation of the driveshaft 7 of the motor 6 results in rotation of the entire inner cylindrical lamp shade 21.

In use, when the pendant type lamp shade 3 is connected to a light fitting such as a conventional bulb holder 4 suspended from a ceiling and the light is switched on the solar cell transducer 5 converts some of the solar energy into electrical energy. The electrical energy powers the motor 6 causing the drive shaft 7 to rotate. The drive shaft 7 acts on the connector 27 of the inner cylindrical lamp shade 21 causing the inner cylindrical lamp shade 21 to rotate relative to the outer cylindrical lamp shade 11. Images on the inner cylindrical lamp shade 21 are projected onto the outer cylindrical lamp shade 11 creating an attractive visual effect for people in the vicinity.

The specific configuration of the lampshade 33 shown in FIGS. 5 to 7 is practically identical to the configuration of the lampshade 3 shown in FIGS. 1 to 4 and like features are identified with the same reference numerals. However in this embodiment, the lampshade 33 is upside down and is mounted on a light fitting 4 of a table lamp indicated generally by the reference numeral 31 having a plinth/base 37 and column 38. The lampshade 33 has a first outer lampshade 11 with a generally cylindrical wire support frame 12 covered in a partially transparent material 13 for partially transmitting light from the light source. Although the shape of the wire support frame 12 is described as generally cylindrical, it will of course be appreciated that any well known shape of lamp shade can be used with the present invention such as hemispherical or frusto-conical. The bottom end of the cylindrical wire support frame 12 has three support members 44 with a central ring 45 for mounting the outer lamp shade 11 from the bulb holder 4 of a traditional table lamp 31. The top end of the cylindrical wire support frame 12 has a lid member 18 fastened to the frame 12 by clips 19 for supporting the motor 6 and transducer 5 centrally thereon. The transducer 5 is provided by photo voltaic solar cells for converting solar to electrical energy. In view of the fact that the motor 6 is inverted it is fastened to the lid member 18 via glue or similar fixing elements. The transducer 5, motor 6 and lid 18 can be clipped into and out of the lampshade wire support frame 12 as a unit to aid ease of assembly in this and any similar embodiment.

A second inner cylindrical lamp shade 21 is provided within the outer cylindrical lamp shade 11 and is concentric there with. The inner cylindrical lamp shade 21 also has a generally cylindrical wire support frame 22 covered in a partially transparent material 23 for partially transmitting light from the light source. The bottom end of the inner cylindrical lamp shade 21 is open and the top end of the inner cylindrical lamp shade 21 has a cruciform wire support base 24 supporting a central wire frame recess 25 for receiving the motor 6 and drive shaft 7. The central wire frame recess 25 also supports a connector 27 in alignment with the drive shaft 7 in use for engaging the drive shaft 7 of the motor 6 so that rotation of the driveshaft 7 of the motor 6 results in rotation of the entire inner cylindrical lamp shade 21. The connector 27 in this embodiment also mechanically couples the inner cylindrical lamp shade 21 to the drive shaft 7 of the motor 6 to prevent the inner cylindrical lamp shade 21 falling down under gravity.

In use, when the lamp shade 33 is connected to the light fitting 4 of a conventional table lamp base 37 and the light is switched on the solar cell transducer 5 converts some of the solar energy into electrical energy. The electrical energy powers the motor 6 causing the drive shaft 7 to rotate. The drive shaft 7 acts on the connector 27 of the inner cylindrical lamp shade 21 causing the inner cylindrical lamp shade 21 to rotate relative to the outer cylindrical lamp shade 11. Images on the inner cylindrical lamp shade 21 are projected onto the outer cylindrical lamp shade 11 creating an attractive moving visual effect for people in the vicinity.

Referring to the drawings and now to FIGS. 8 to 10, there is shown a third embodiment of lighting arrangement indicated generally by the reference numeral 51 having a similar construction of lampshade 53 to the two lampshades 3, 33 described above. The lampshade 53 is mounted on a base member 54 and has a first outer lamp shade 11 with a generally cylindrical wire support frame 12 covered in a partially transparent material 13 for partially transmitting light from the light source. Although the shape of the wire support frame 12 is described as generally cylindrical, it will of course be appreciated that any well known shape of lampshade can be used with the present invention such as hemispherical or frusto-conical. The bottom end of the cylindrical wire support frame 12 is connected directly to the base member 54. The top end of the cylindrical wire support frame 12 has a housing 56 for holding a light fitting 57 and a container 58 for rechargeable batteries. The rechargeable batteries are electrically coupled to a recharging solar cell 59 which is exposed to daylight or powered light from another source where the lighting arrangement 51 is located and charges the batteries when so exposed.

A motor 61 is mounted on the base member 54 and has a transducer 62 electrically coupled thereto. The transducer 62 is provided by photo voltaic solar cells for converting solar to electrical energy.

A second inner cylindrical lamp shade 21 is provided within the outer cylindrical lamp shade 11 and is concentric there with. The inner cylindrical lamp shade 21 also has a generally cylindrical wire support frame 22 covered in a partially transparent material 23 for partially transmitting light from the light source. The top end of the inner cylindrical lamp shade 21 is open to facilitate charging of the transducer 5 and the bottom end of the inner cylindrical lamp shade 21 has a central wire frame recess 25 for receiving the motor 6 and drive shaft 7. The central wire frame recess 25 also supports a connector 27 in alignment with the drive shaft 7 in use for engaging the drive shaft 7 of the motor 6 so that rotation of the driveshaft 7 of the motor 6 results in rotation of the entire inner cylindrical lamp shade 21.

In use, during the day or when the recharging solar cell 59 is exposed to natural or powered light, the batteries are charged. When a person switches on the lamp 51 the batteries discharge in to the light source such as a bulb connected to the light fitting 57. When the light source in the lamp 51 is switched on the solar cell transducer 5 converts some of the solar energy into electrical energy. The electrical energy powers the motor 6 causing the drive shaft 7 to rotate. The drive shaft 7 acts on the connector 27 of the inner cylindrical lamp shade 21 causing the inner cylindrical lamp shade 21 to rotate relative to the light fitting and the outer cylindrical lamp shade 11. Images on the inner cylindrical lamp shade 21 are projected onto the outer cylindrical lamp shade 11 creating an attractive moving visual effect for people in the vicinity.

Referring now to FIG. 11, there is shown a fourth embodiment of lamp and movable lampshade indicated generally by the reference numeral 1. The lamp 1 has an arrangement indicated generally by the reference numeral 2 for causing relative movement between at least a portion of the lampshade 3 and the coupling member 107. The arrangement 2 for causing movement has a transducer 5 for converting solar energy to electrical energy.

Advantageously, the transducer 5 is capable of converting a portion of the existing light energy from a light source such as bulb 106 mountable in the light fitting 4 into useful electrical energy which is otherwise unused dissipating into the atmosphere.

The arrangement 2 for causing movement also has an actuator 6 powered by the electrical energy generated by the transducer 5 and in the embodiments shown in the drawings is a motor 6. The motor 6 has a driveshaft 7 operably engageable with a rotatable component 9 of the lampshade 3.

The motor 6 is operable between the transducer 5 and the rotatable component 9 of the lampshade 3 for causing relative movement between the lampshade 3 and the light fitting 2.

The specific configuration of the lampshade 3 shown in FIG. 11 has a single lamp shade 11 with a generally frusto-conical wire support frame 12 covered in a partially transparent material 13 for partially transmitting light from the light source. Although the shape of the wire support frame 12 is described as generally frusto conical, it will of course be appreciated that any well known shape of lamp shade can be used with the present invention such as hemispherical or frusto-conical. The bottom end of the frusto conical wire support frame 12 has a rotatable member 9 which is coupled to the drive shaft 7. A coupling member 107 is provided by a substantially rectangular wire mounting frame 107 mounted on the bulb holder 4 and the motor 6 and transducer 5 are mounted on the rectangular frame 107 on the end opposite the bulb holder 4. The transducer 5 is provided by photo voltaic solar cells for converting solar to electrical energy. In use, the bulb 106 is switched on and the transducer 5 converts some of the solar energy into electrical energy to power the motor 6 and rotate the drive shaft 7. The rotatable member 9 is free to rotate as the drive shaft 7 turns thereby rotating the lampshade 3. Mobiles 108 are suspended from the lampshade 3 and rotate therewith.

In an alternative embodiment not shown in the drawings, the actuator is provided by a fan blowing a stream of air onto a rotatable portion of the lampshade which has turbines for receiving the stream of air from the fan causing the lampshade to rotate.

Referring now to FIGS. 12 to 14 there is shown a fourth embodiment of lighting arrangement in the form of a centre light indicated generally by the reference numeral 71 having three lighting arrangements 72 equi-angularly spaced around a mounting column 73 of the centre light 71. Each lighting arrangement 72 has a light fitting comprising a bulb holder 75 and a locking cap 76 for securing a coupling member 77 provided by a wire support frame 77 onto the light fitting. One side of the wire support frame 77 is mounted on the bulb holder 75 via a ring and the opposing side has a ring 78 with an aperture for receiving a drive shaft 79 of the motor 80 there through to secure the motor 80 onto the wire support frame 77. A transducer 81 in the form of a photovoltaic cell is mounted on the underside of the motor housing in direct line of sight to the bulb 82. The motor 80 and transducer 81 are above the bulb 82 in this embodiment. The drive shaft 79 of the motor 80 is attached to a closure cap 83 which is attached to and seals an aperture in the tapered end of a frusto-conical lampshade 84. In use, when an operator switches the centre light 71 on, the transducer 81 converts some of the normally wasted solar energy into electric energy and the motor 80 converts this electricity into rotational motion causing the lampshade 84 to rotate.

Referring to FIGS. 15 to 19, there is shown a sixth embodiment of lighting arrangement indicated generally by the reference numeral 91 having a light fitting comprising a bulb holder 95 and a locking cap 96 for securing a coupling member 97 provided by wire support frame 97 onto the bulb holder 95. One side of the wire support frame 97 is mounted on the bulb holder 95 via a ring and the opposing side has a ring 98 defining an aperture for receiving a drive shaft 99 of a motor 90 there through to secure the motor 90 onto the wire support frame 97. A transducer 101 in the form of a photovoltaic cell is mounted on the top of the motor housing in direct line of sight to the bulb 102. In this embodiment, the photovoltaic cell 101 and the motor 90 are below the bulb 102. The drive shaft 99 of the motor 90 is releasably attachable to a connector member 106 centrally mounted on a plate 103 which is attached to lampshade 104 via three support members 105. In use, when an operator switches the light on, the transducer 101 converts some of the normally wasted solar energy into electric energy and the motor 90 converts this electricity into rotational motion causing the lampshade 104 to rotate.

Referring to FIGS. 20 to 22, there is shown a seventh embodiment of lighting arrangement indicated generally by the reference numeral 111 having a light fitting comprising a bulb holder 115 and a locking cap 116 for securing a lamp shade 113 onto the light fitting.

The specific configuration of the lampshade 113 is a first frusto-conical outer lamp shade 119 covered in a partially transparent material for partially transmitting light from the light bulb 118. The lamp shade has a wire support frame 123 and a top part of the wire support frame 123 has a three part member 117 with a central ring 125 for hanging the outer lamp shade 119 from a light fitting such as the traditional bulb holder 115 and locking cap 116 combination hanging from the ceiling. The bottom end of the wire support frame 123 has an end cap 128 fastened to a plate member 126 which is connected to the frame 123. The other side of the plate member 126 supports the motor 129 and transducer 130 centrally thereon. The transducer 130 is provided by photo voltaic solar cells for converting solar to electrical energy.

A second inner lamp shade 131 is provided within the outer lamp shade 119 and being concentric there with. The inner lamp shade 131 also has a generally wire support frame 132 covered in a partially transparent material 133 for partially transmitting light from the light bulb 118. The top end of the inner lamp shade 131 is open and the bottom end of the inner lamp shade 131 has a central wire frame recess 135 for receiving the motor 129 and drive shaft 127. The central wire frame recess 135 also supports a connector 137 in alignment with the drive shaft 127 in use for engaging the drive shaft 127 of the motor 129 so that rotation of the driveshaft 127 of the motor 129 results in rotation of the entire inner lamp shade 131.

In use, when the pendant type lamp shade is connected to a light fitting such as a conventional light fitting suspended from a ceiling and the light is switched on the solar cell transducer 130 converts some of the solar energy into electrical energy. The electrical energy powers the motor 129 causing the drive shaft 127 to rotate. The drive shaft 127 acts on the coupler 137 of the inner lamp shade 131 causing the inner lamp shade 131 to rotate relative to the light fitting and the outer lamp shade 119. Images on the inner cylindrical lamp shade 131 are projected onto the outer lamp shade 119 creating an attractive visual effect for people in the vicinity.

Referring to the drawings and now to FIGS. 23 to 28, there is shown an eighth embodiment of lighting arrangement indicated generally by the reference numeral 141 where the lampshade 142 has a wire support frame 143 with a partially transparent covering material 140 creating a cylindrical side wall. A cross member 146 with a central ring 147 extends across the top of the wire support frame 143 for coupling the lampshade 142 to a light bulb holder. An aperture 148 is formed in two opposing locations of the side wall of the lampshade 142 and a motor 149 is mounted on the inside of the lampshade 142 with the drive shaft 150 extending through each aperture 148 and coupled to a rotatable display member 151. A transducer 152 in the form of a photovoltaic cell is mounted on the side of the motor housing facing the light source. In use, solar energy from the light source causes the motor to rotate the display member 151 creating an attractive display on the outside surface of the lampshade 142.

Referring to the drawings and now to FIGS. 29 to 34, there is shown a ninth embodiment of lighting arrangement indicated generally by the reference numeral 161 having a light fitting comprising a bulb holder 165 and a locking cap 166 for securing a coupling member provided by a wire support frame 167 onto the light fitting. One side of the wire support frame 167 is mounted on the bulb holder 165 via a ring and the opposing side has a ring 168 defining an aperture for receiving a drive shaft 169 of a motor 170 there through to secure the motor 170 onto the wire support frame 167. A transducer 171 in the form of a photovoltaic cell is mounted on the top of the motor housing in direct line of sight to the bulb 162. In this embodiment, the photovoltaic cell 171 and the motor 170 are below the bulb 162. The drive shaft 169 of the motor 170 is releasably attachable to a wire 173 which supports a cross member 174 carrying a mobile 175 on the end of a string 176 suspended from each end of the cross member 174. In use, when an operator switches the light on, the transducer 171 converts some of the normally wasted solar energy into electric energy and the motor 170 converts this electricity into rotational motion causing the mobiles 175 to rotate.

Referring to FIGS. 35 to 39, there is shown a tenth embodiment of lighting arrangement indicated generally by the reference numeral 181 having a light fitting comprising a bulb holder 185 and a locking cap 186 for securing a coupling member 187 provided by a wire support frame 187 onto the light fitting.

The specific configuration of this lampshade 188 is a cylindrical wire support frame 192 carrying a first cylindrical outer lamp shade 189 having a plurality of apertures 190 formed in the lampshade 189. The apertures 190 transmit images carried on an internal lampshade 191. The top end of the cylindrical wire support frame 192 of the outer lampshade 189 has a cross member 194 with a central ring 195 for hanging the outer lamp shade 189 from the traditional bulb holder 185 and locking cap 186 combination hanging from the ceiling. The bottom end of the wire support frame 192 is open.

One side of the wire support frame 187 is mounted on the bulb holder 185 and the opposing side has a ring 188 defining an aperture for receiving a drive shaft 199 of a motor 190 there through to secure the motor 190 onto the wire support frame 187. A transducer 197 in the form of a photovoltaic cell is mounted on the top of the motor housing in direct line of sight to the bulb 193. In this embodiment, the photovoltaic cell 197 and the motor 190 are below the bulb 193. The drive shaft 199 of the motor 190 is releasably attached to a coupling member 198 centrally mounted on a plate 200 which is attached to the inner lampshade 191 via three wire support members 205. In use, when an operator switches the light on, the transducer 197 converts some of the normally wasted solar energy into electric energy and the motor 190 converts this electricity into rotational motion causing the lampshade 191 to rotate. As the inner lampshade 191 rotates the images on the inner lampshade 191 are visible through the apertures 190 in the outer lampshade 189.

Referring to the drawings and now to FIGS. 40 to 46 there is shown a twelfth embodiment of lighting arrangement indicated generally by the reference numeral 211 provided by a table lamp. The table lamp 211 has a plinth 212 and an upstanding support column 213 for supporting a light fitting comprising a bulb holder 215 and a locking cap 216 for securing a coupling member provided by a wire support frame 217 onto the light fitting.

One side of the wire support frame 217 is mounted on the bulb holder 215 and the opposing side has a ring 218 defining an aperture for receiving a drive shaft 219 of a motor 220 there through to secure the motor 220 onto the wire support frame 217. A transducer 221 in the form of a photovoltaic cell is mounted on the bottom of the motor housing in direct line of sight to the bulb 223. In this embodiment, the photovoltaic cell 221 and the motor 220 are above the bulb 226. The drive shaft 219 of the motor 220 is releasably attachable to a connector on a plate 227 which is attached to a lampshade 228. In use, when an operator switches the light on, the transducer 221 converts some of the normally wasted solar energy into electric energy and the motor 220 converts this electricity into rotational motion causing the lampshade 228 to rotate.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

1-21. (canceled)

22. A lighting arrangement, comprising:
a coupling system operable to couple the lighting arrangement to a bulb holder and a lampshade supported on the coupling system; and
a movement causing system operable to cause relative movement between at least a portion of the lampshade and the coupling system, the movement causing system comprising a transducer for converting solar energy to electrical energy.

23. The lighting arrangement as claimed in claim 22, wherein the movement causing system further comprises an actuator system powered by the electrical energy generated by the transducer.

24. The lighting arrangement as claimed in claim 23, wherein the actuator system is a motor.

25. The lighting arrangement as claimed in claim 24, wherein the actuator system is operably engaged between the transducer and at least a portion of the lampshade.

26. The lighting arrangement as claimed in claim 25, wherein the motor has a driveshaft operably engaged with a rotatable portion of at least a portion of the lampshade.

27. The lighting arrangement as claimed in claim 26, wherein the coupling system is a coupling support frame.

28. The lighting arrangement as claimed in claim 27, wherein the movement causing system is mounted on the coupling support frame.

29. The lighting arrangement as claimed in claim 28, wherein the coupling support frame comprises a wire frame having a first ring connectable to a light bulb holder and a second ring for engaging the motor thereon and for receiving the driveshaft of the motor there through.

30. The lighting arrangement as claimed in claim 29, wherein the drive shaft of the motor is operably engaged with a rotatable portion of the lampshade.

31. The lighting arrangement as claimed in claim 30, wherein the lampshade has a first inner rotatable lampshade member connected to the motor and a second outer lampshade member fixable to the light source, the second outer lampshade member having at least one aperture.

32. The lighting arrangement as claimed in claim 31, wherein the inner lampshade member and the outer lampshade member are of similar shapes and are concentric.

33. The lighting arrangement as claimed in claim 32, wherein the lampshade has a lampshade support frame and the coupling system is a part of the lampshade support frame.

34. The lighting arrangement as claimed in claim 33, wherein the lampshade has an outer lampshade member fixable to the light source via the coupling system and an inner lampshade member movably mounted on the outer lampshade member via the movement causing system.

35. The lighting arrangement as claimed in claim 34, wherein the inner lampshade member and the outer lampshade member are of similar shapes and are concentric.

36. The lighting arrangement as claimed in claim 35, wherein the movement causing system has the motor and transducer mounted on the support frame of the outer lampshade member.

37. The lighting arrangement as claimed in claim 36, wherein the support frame of the inner lampshade member has a recess for receiving the motor and a connector for engaging the drive shaft of the motor.

38. The lighting arrangement as claimed in claim 22, wherein the lampshade has at least one mobile attached thereto.

39. The lighting arrangement as claimed in claim 22, wherein the lighting arrangement is attachable to a pendant type light fitting, a pendant centre light, a recessed light, a table lamp or a floor lamp.

40. The lighting arrangement as claimed in claim 22, wherein the transducer is provided by at least one photovoltaic solar cell for converting solar to electrical energy.

41. The lighting arrangement as claimed in claim 22, wherein a sound generating system is electrically or electronically coupled to the transducer.
